(19) United States
(12) Patent Application Publication
(10) Pub. No.: US 2003/0094103 A1
(43) Pub. Date: May 22, 2003

(54) Apparatus for air-guiding

(76) Inventors: Wen Hsing Chiu, Tou Fen Jen (TW); Tseng Chang Chiang, Tou Fen Jen (TW)

Correspondence Address: RABIN & CHAMPAGNE, P.C., 1101 14th Street, N.W., Suite 500, Washington, DC, 20005, US

(21) Appl. No.: 09/987,959

(22) Filed: Nov. 16, 2001

(51) Int. Cl. B01D 51/08

(52) U.S. Cl. 96/389

(57) ABSTRACT

The present invention, a apparatus for air-guiding, is that an engine uses an air filter to collocate with an airplate with good vibration property. After passing through the air plate, the air produces resonance and increases its speed. That is to sat, the distance of air molecule is short and the density is high. A unit space can contain more air of preferred quality. The engine space has enough normal air and fuel-oil to mix well and to get full combustion. The engine operates smoothly and reduces the pollution to improve the air quality of the environment.

### BACKGROUND OF THE INVENTION

1. Field of the Invention

This invention relates to a air-guiding device, more particularly a device of which fluid air through an air filter is accelerated and high-frequency and forms preferred density and enter into the chamber of the mixture so that guide gas of full-combustion increases the speed of flow through the component.

2. Description of the Related Art

A cylinder of an ordinary internal combustion, like a diesel engine or a gasoline engine, connects with an air filter. External air would first pass through an air strainer screen of the air filter and is guided into the cylinder by connecting with a communicating pipe. At the same time, a carburetor would mix fuel-oil and an ejector would eject the mixture to a combustion chamber. At last, an electrified sparking plug fires the mixture inside the combustion chamber. Fuel-oil and air in the combustion chamber must well mix and evaporate; then, they can be fired. The reason that they do not well mix is mainly the mixed proportion of oxygen content of fuel-oil and air. For example, in the downtown or in a section of a traffic jam, the environment is filled with exhaust gas that causes the quantity of normal air to reduce. It easily causes the combustion state of the burning gas in the combustion chamber to be not uniform. If part of fuel-oil and air is well-mixed, then, the well-mixed mixture is full combustion. If part of fuel-oil and air is not well-fixed, then, it is not full combustion. It would probably delay and accompany with others to re-inflame. Alternatively, it will have a sudden re-combustion. These situations would cause the engine to operate skippingly.

No matter a two stroke engine or a four stroke engine, however, its forming time of induction, compression, firing, inflation, and suction has a specific proportion. Therefore, if air quality is bad (the proportion of exhaust gas and normal air is too high) in the condition of a specific induction time, it would cause that the quantity of normal air is terribly lack, and fuel-oil as well as air (normal air) do not mix well. The phenomenon of skipping operation is more obvious. It is also inconvenient and troublesome in use.

### SUMMARY OF THE INVENTION

Seeing that an engine want to have fuel-oil and air mix well, The air quantity of a unit volume will increase to make the engine space have enough air and fuel-oil to be well-mixed and well and complete combustion so that the engine can operate normally. As a result, the inventor vigorously research and improve this invention, so the present invention is invented.

The object of the present invention is to provide an apparatus for air-guiding to guide gas to flow through air plate to increase the speed of flow. It will make a unit space contain more air. And the engine will have enough normal air and fuel-oil to be well-mixed, well and complete combustion, and gasoline-saving.

Therefore, according to the device to guide gas to pass through the component to increase the speed of flow of the present invention, an air plate forms a substance with good vibration property and connects with a gas-guiding device. The substance densely spreads over a lot of penetrating gas-guiding passages. By means of the gas-guiding device to guide the air to pass the gas-guiding passages, the air collides the air plate. The substance forms vibration because of the flow. Air produces resonance because of vibration and accelerates the speed. Air become preferred density in the space to offer enough gas to the user of the power device.

### BRIEF DESCRIPTION OF THE DRAWINGS

Other processes, structures, features and advantages of the present invention will become apparent in the following detailed description of the preferred embodiment of the invention, with reference to the accompanying drawings, in which:

FIG. 1 is schematic view illustrating the air filter and air plate of the first preferred embodiment of the invention;

FIG. 2 is a diagram of the front view of the air plate of the first embodiment of the invention;

FIG. 3 is a diagram of the side view of the air plate of the first embodiment of the invention;

FIG. 4 is a diagram which air flows through the air plate of the first preferred embodiment of the invention.

### DETAILED DESCRIPTION OF THE PREFERRED EMBODIMENTS

Before the present invention is disclosed in greater detail, it should be noted that like elements are denoted by the same reference numerals throughout the disclosure.

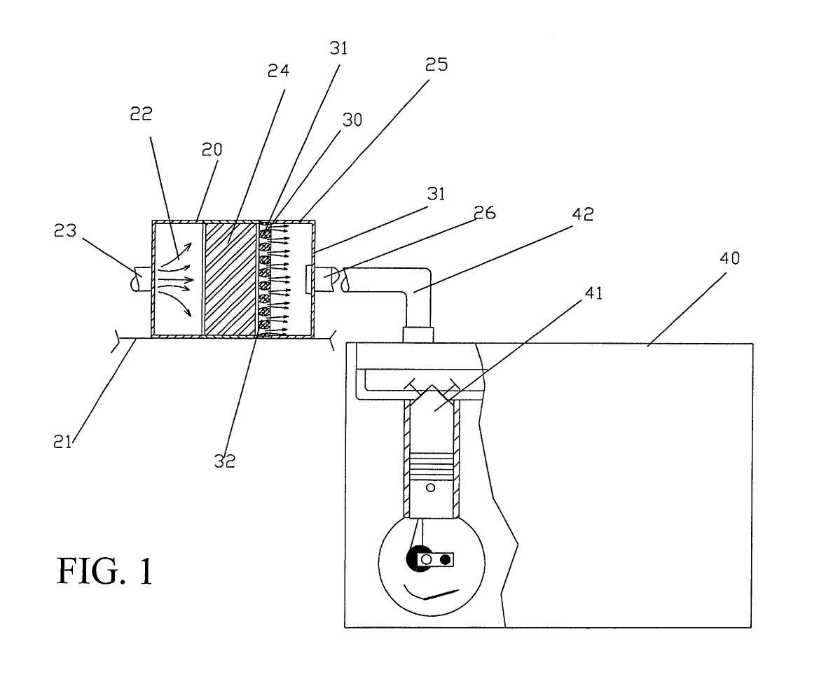

Please referring to FIG. 1, the preferred embodiment of the present invention, a apparatus for air-guiding to guide air to flow through device to increase the speed of flow, the structure is consisted of a gas-guiding device {which means an air filter (20) in the invention}, an air plate (30), a power device {which means the engine (40) in the invention}:

The air filter (20), please referring to FIG. 1, is set mounted in a rack (20). The inside of the air filter (20) is a concave contain space (22). The contain space (22) connects an induction pipe (23) to guide external air. One side of a strainer screen set (24), which lets air pass and obstruct foreign matter or big granular impurities, is closely connected with the contain space (22). A fixed hood (25) is closely connected with the strainer screen set (24). The fixed hood (25) connects with a suction pipe (26) to guide the filtered air.

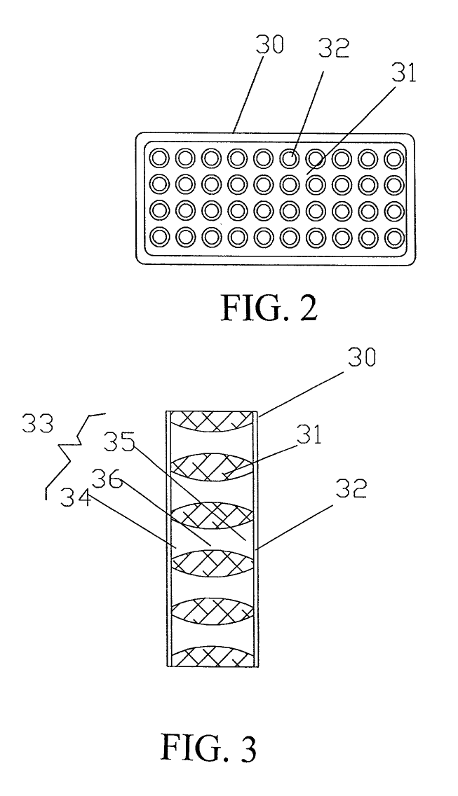

The air plate (30), please referring to FIGS. 2 and 3, forms a substance (31) with Dymacon. pp-c added with glass fiber and the specific proportion of Zr and alkali. The substance (31) of the preferred embodiment uses 59% of Dymacon. pp-c, 25% of glass fiber, 2.5% of Mg, 3.5% of Zr, 10% of alkali. The materials are fused with heat and a machine is used to form the substance (31). The substance (31) is made up by compound material and metal elements. It possesses properties of alloy, lightness, heat endurance, high hardness, and good vibration. The substance (31) spreads over a lot of penetrating gas-guiding passages (32). The gas-guiding passages (32) uniformly arrange with appropriate distance and the same intervals. It forms a penetrating passage (33). The passage (33) forms an inlet (34) and an outlet (35) that two out-sides gradually shrink inward. The center of the passage (33) forms a throat (36) of a smaller section. The throat (36) is bulged-shaped and protrudes into the passage (33). Two sides of the throat (36) smoothly connect with the inlet (34) and the outlet (35).

The engine (40), please referring to FIG. 1, is a combustion chamber (41) with a carburetor and an ejector to connect with an inlet pipe (42). The combustion chamber (41) has a specific space to contain the mixture of oil gas that is ejected by the carburetor and the ejector. The inlet pipe (42) connects with an outlet pipe (26). The combustion chamber (42) of the engine (40) collocates with piston activity to form strokes of induction, compression, function, and suction. We will not describe these strokes, because they are the learned skill.

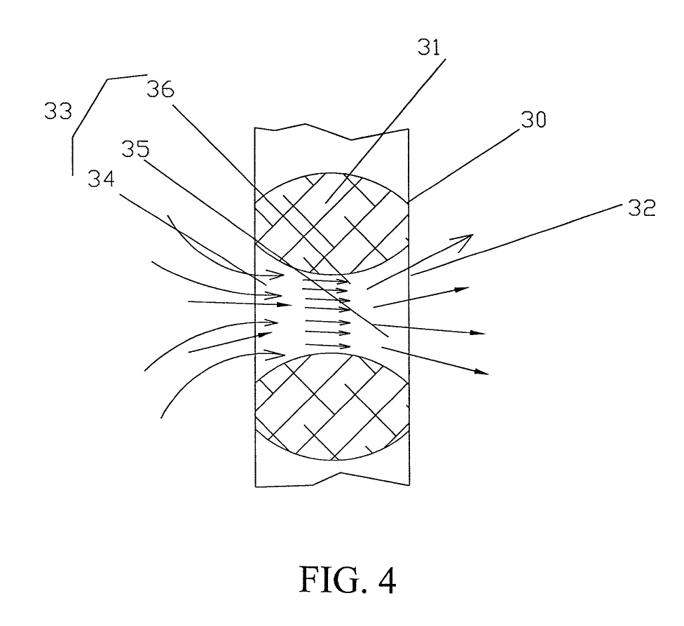

With the above-mentioned structures, please referring to FIGS. 1 and 4, when the engine (40) starts to operate, an air pump pumps external air into the induction pipe (23) of the air filter (20). When external air flows into the contain space (22), it will first proceed to initial filtering by the strainer screen set (24) to obstruct foreign matter and big granular impurities. Then, the flow meets the air plate (30) and enters from the inlet (34) of the (33). It is obvious that the air would be squeezed and collide the side of the passage (33), because the air flows to a smaller space of the passage (33) from a vast space of the contain space (22). The throat (36) will bulge and protrude into the passage (33). The gas-guiding passages (32) obstruct the air, and the effect of collision of the air is better. Since the substance (31) possesses properties of lightness and good vibration, it will vibrate while being squeezed and collided by the air. The bulged-shape of the throat (36) will make the effect of vibration even better.

The substance (31), corresponding with the passage (33), forms a base to produce outward-moving vibration wave. The vibration wave which is produced by vibration frequency of the substance (31) travels to the center of the passage (33). And the vibration wave functions the air inside the passage (33). The speed of movement of air molecule brcomes fast because of vibration. There will be more air molecule passing through a unit space at the same time. It means that a unit space can contain more air molecule; that is, the density of air molecule increases. A large number of air molecule will be easily collide with the wall of the passage (33), and the wall of the passage (33) will produce bigger pressure. The substance (31) is a base that produces pressure and vibration after being collided.

The passage (33) of the present invention gradually shrink inwardly from the extensive volume of out-side of the inlet (34), until the inlet (34) connects with the throat (36) to form the smallest volume. After air molecule enters the passage (33), it will produce resonance and forms kinetics increase because of vibration of the substance (31). Relatively, the speed of air molecule movement is faster. Air molecule moves gradually from the inlet (34) to the throat (36) in the passage (33). Pressure and vibration produced by the substance (31), which is collided by air molecule, also increase. Resonance frequency of air molecule is stronger. After the compression, air molecule possesses properties of high speed and density. It flows out from the outlet (35) and air becomes the preferred quality. That is to say, a unit volume can contain more quantity of air molecule and the number of oxygen content of the internal also increases.

As a result, when the outlet (35) let air of preferred quality into the suction pipe (26) to connect with the inlet pipe (24) and the combustion chamber (42) collocates with a carburetor and an ejector to connect with the inlet pipe (24), air of preferred quality flows from the inlet pipe (24) into the combustion chamber (42) after passing through the carburetor and the ejector. Because the combustion chamber (42) has a fixed volume, the combustion chamber (42) of the engine (40) collocates with piston activity to form strokes of induction, compression, function, and suction. They operate in a specific time and order, so fuel and gas are ejected into the combustion chamber (42) in a specific time. The density and quantity of oil and gas are also kept the same; therefore, total quantity is constant. Since the present invention forms air of preferred quality, and the same volume can contain more quantity of air molecule, piston activity of the engine (40) ejects more air molecule to the combustion chamber (42) in a specific time. The engine (40) can get more and sufficient air to have air and oil in the combustion chamber (42) mix well and to reach the effect of full combustion. This will reduce the suction of oil gas without full combustion and oil-consuming to save energy.

Obviously, the invention, that the air filter (20) collocates with the air plate (30) to produce air of preferred quality, can provide sufficient air and oxygen to let air and oil in the combustion chamber (42) completely and well mix and have uniform and full combustion. Therefore, the engine (40) can operate smoothly. Especially, in the road section of downtown a and a traffic jam, the oxygen supply can keep a specific quantity with the invention to promote the supply of air. It can avoid the phenomenon of obviously shaking and unstable operation of the engine.

What is worth of mentioning, the present invention makes oil to get full combustion in the engine (40). It will substantially reduce the suction of exhaust gas without combustion. This will be a great improvement for the air pollution of suction of exhaust gas without full combustion of autos and motorcycles. It has a great effect on improving air quality of the environment.

Besides, a break of an auto is a vacuum pump to help the air filter (20) to let out air, when the invention is used in an auto. With the collocation of the air plate (30), it can change the vacuum pump gas-guiding, then, the distance of air molecule which is needed by an auto's break becomes short (high density). It will make the density of air molecule high when vacuum pump gas-guiding is used in the break system. The compression will be reduced. As a result, while treading and squeezing air, air compression is low and can be more straight and quickly to drive the break system. When the user treads the break system during the driving, the effect of the break will be better.

To sum up, an apparatus for guiding gas to pass through components to increase the speed of flow of the present invention, an air plate becomes a substance with good vibration property and a structure of passage of gas-guiding device. After passing through the air plate, air produces resonance and increases its speed. A unit space can contain more air. Engine space has enough air and fuel-oil to be well-mixed, full combustion, and oil-saving. It possesses the industrial usage and the novelty of the first invention. The structure describe by the present invention is to be considered the preferred embodiment. The present invention is not restricted in the disclosed embodiment but including the spirit and arrangement of the invention.

I claim:

1. An apparatus for air-guiding, comprising:
a gas-guiding device has an induction pipe to guide external air to provide enough quantity of air for a power device;
a set of air plate connects with said gas-guiding device and said induction pipe, Said air plate also forms a substance with the property of good vibration, Said substance produces vibration after being collided, Said substance spreads over a lot of penetrating gas-guiding passages;
By means of said gas-guiding passages to guide the air to pass said air plate, the air collides the wall of said gas-guiding passages, Said substance forms vibration because of the flow, The vibration wave is transmitted to said gas-guiding passages, Said air is forced to resonate and to accelerate in said gas-guiding passages of vibration wave, The fast moving air forms preferred density of gas and provides enough quantity of gas for users of said power devices.

2. The apparatus for air-guiding as claimed in claim 1, wherein, said gas-guiding passages form a passage, of which shape of two outward extending sides, The center of the passage forms a throat stretched by a smaller section, said passage is a smooth shape to let air flow to squeeze in the passage and to flow smoothly, It produces bigger pressure in said passage and makes the substance's vibration stronger.

3. The apparatus for air-guiding as claimed in claim 1, wherein, said substance is made up by compound material and metal elements that possesses the property of alloy, Said substance is heat endurance, high hardness, Said substance forms a base to produce high vibration wave, which can be transmitted to inside of said gas-guiding passages to produce vibration frequency function the gas.

4. The apparatus for air-guiding as claimed in claim 2, wherein, said substance is made up by compound material and metal elements that possesses the property of alloy, Said substance is heat endurance, high hardness, Said substance forms a base to produce high vibration wave, which can be transmitted to inside of said gas-guiding passages to produce vibration frequency function the gas.
